(19) United States
(12) Patent Application Publication
(10) Pub. No.: US 2017/0303111 A1
(43) Pub. Date: Oct. 19, 2017

(54) SYSTEM AND METHOD OF DEVICE PROFILING FOR TRANSACTION SCORING AND LOYALTY PROMOTION

(71) Applicant: MasterCard International Incorporated, Purchase, NY (US)

(72) Inventor: Manoneet Kohli, O'Fallon, MO (US)

(21) Appl. No.: 15/131,718

(22) Filed: Apr. 18, 2016

(51) Int. Cl. H04W 4/24; H04W 8/18; H04M 1/725; G06Q 20/32; H04L 29/08; G06Q 20/40; H04W 12/06; H04M 15/00

(52) U.S. Cl. CPC H04W 4/24; H04W 12/06; H04W 8/183; H04M 15/61; G06Q 20/3224; H04L 67/303; G06Q 20/401; H04M 1/72544

(57) ABSTRACT

A method includes receiving current device profile data with respect to a mobile device. The method further includes comparing the received current device profile data with stored reference device profile data. In addition, the method includes making a device authentication determination with respect to the mobile device based at least in part on a result of the comparing step. The received current device profile data and the stored reference device profile data are indicative of at least one application program characteristic of the mobile device.

### BACKGROUND

Payment accounts are in widespread use for both in-store and online purchase transactions. FIG. 1 is a block diagram of a previously proposed version of a payment system (generally indicated by reference numeral 100) as it may operate in connection with an online purchase transaction.

The system 100 includes an e-commerce server computer 102 that may be operated by or on behalf of an online merchant to permit online shopping transactions. For this purpose, as is well known, the e-commerce server computer 102 may host a shopping website, sometimes referred to as an “online store”. A customer 103 who operates a customer device 104 may access the shopping website by communicating over the Internet 105 with the e-commerce server computer 102. In many instances, the customer device 104 is a mobile device such as a suitably programmed smartphone that runs a mobile browser.

As is very familiar to those who shop online, after the customer has selected one or more items of merchandise for purchase from the online store, he/she may elect to enter a checkout phase of the online purchase transaction. In some situations, during the checkout phase, the customer enters payment information, such as a payment account number, expiration date, security code, etc. into an online form. However, according to some proposals, the customer may be presented with an option to select use of the customer's digital wallet, which has been stored in a wallet service provider's computer 106. The digital wallet may contain data relating to several of the customer's payment accounts, and selecting the digital wallet option may result in the customer being presented with the opportunity to select one of those payment accounts for use in the current online purchase transaction. Upon the customer indicating selection of one of the accounts in the digital wallet, the wallet service provider 106 may make the corresponding data (again, payment account number, expiration date, security code, etc.) for the selected account available to the merchant's e-commerce server 102.

In connection with the online purchase transaction, the e-commerce server computer 102 may transmit a transaction authorization request message (sometimes simply referred to as an “authorization request”) to the merchant's acquirer financial institution (“acquirer” or “transaction acquirer”), indicated by reference numeral 110. Assuming that the digital wallet scenario described above had occurred, the authorization request may include the payment data provided from the wallet service provider 106 to the e-commerce server 102.

The acquirer 110 may route the authorization request via a payment network 112 to a server computer 114 operated by the issuer of the payment account that corresponds to the payment data included in the authorization request. Also, the authorization response generated by the issuer server computer 114 may be routed back to the acquirer 110 via the payment network 112. The acquirer 110 may confirm to the merchant (i.e., to the e-commerce server computer 102) that the transaction has been approved.

The payment network 112 may be, for example, the well-known Banknet® system operated by MasterCard International Incorporated, which is the assignee hereof.

The components of the system 100 as depicted in FIG. 1 are only those that are needed for processing a single transaction. Those who are skilled in the art will recognize that in the real world, online shopping and payment systems may process many purchase transactions (including simultaneous transactions) and may include a considerable number of payment account issuers and their computers, a considerable number of acquirers and their computers, and numerous merchants and their e-commerce servers. The system may also include a very large number of customers/online shoppers, who hold payment accounts that they use for their online shopping activities. In some environments there may also be a number of wallet service providers. It is also well known that elements of the system 100 (e.g., acquirers, the payment network, payment account issuers) may play similar roles in connection with in-store purchase transactions and in other types of transactions.

In some online transactions, a device authentication procedure may be applied to the customer device being used in the transaction to help guard against fraudulent transactions. The present inventor has recognized opportunities for improvements in device authentication procedures. The present inventor has also recognized opportunities for improving marketing of promotional offers via user devices.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional system that handles online purchase transactions.

FIG. 2 is a block diagram of a payment system according to some embodiments.

FIG. 3 is a block diagram of a typical mobile device that may be used in connection with the payment system of FIG. 2.

FIGS. 4, 5, 6 and 7 are block diagram representations of computers that may serve as components of the system shown in FIG. 2.

FIGS. 8, 9 and 10 are flow charts that illustrate aspects of the present disclosure.

### DETAILED DESCRIPTION

In general, and for the purpose of introducing concepts of embodiments of the present disclosure, an authentication service for online transactions may perform device authentication processes based on characteristics of a user device in regard to application programs (apps) that are operating in the user device. Among other app-related characteristics that may be employed in connection with device authentication are: (a) which apps or types of apps are present in the user device; (b) one or more dates on which the app(s) were configured for use in the user device; and (c) data usage, power usage, and/or frequency of use statistics relative to the apps on the user device. Similar app-related characteristics may be utilized in selecting promotional offers to be transmitted to the use device.

Teachings of the present disclosure may also be applied in the context of in-store payment account transactions.

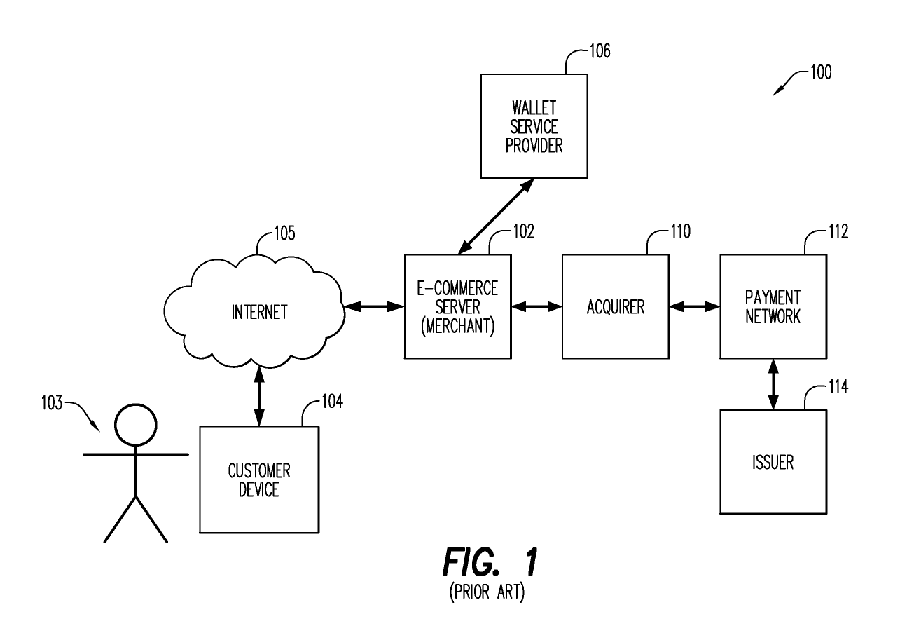

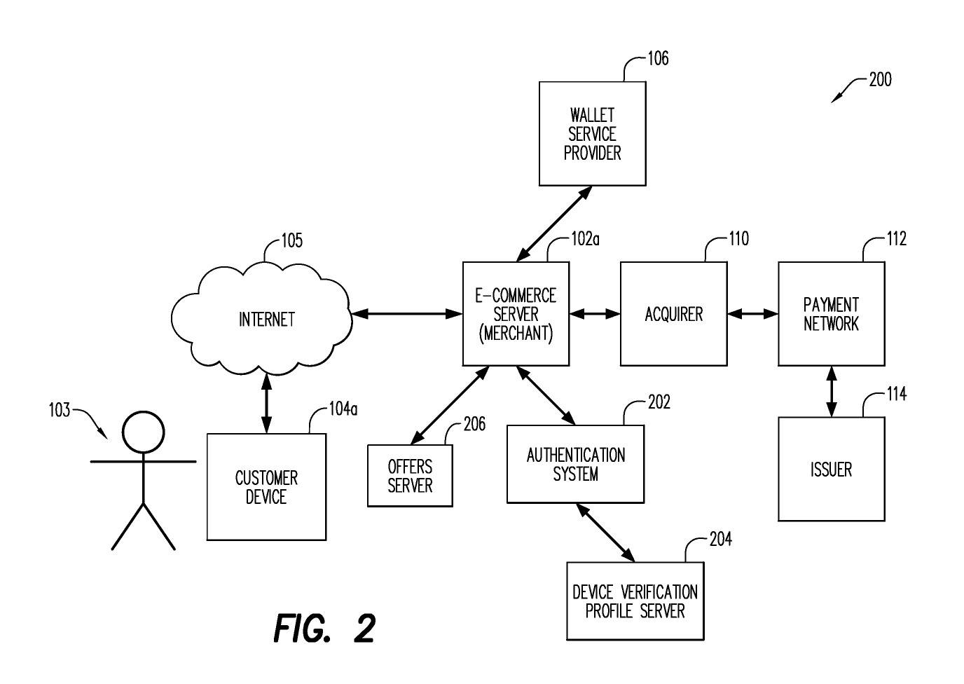

FIG. 2 is a block diagram of a payment system 200 provided according to some embodiments. The payment system 200 incorporates all of the elements referred to above in connection with FIG. 1. It should be noted, however, that some elements may be in modified form or may have been programmed in a somewhat different manner than the elements shown in FIG. 1. For example, elements/entities 103, 104, 105, 106, 110, 112 and 114 are carried over in the payment system 200 as depicted in FIG. 2 from the depiction of the payment system 100 shown in FIG. 1. Moreover, a customer device 104a is shown in association with the user 103 and in operation in connection with an online shopping transaction. The customer device 104a may be programmed to have capabilities as described in this disclosure. An e-commerce server 102a is also shown as playing a central role in the transaction. The e-commerce server 102a may also have capabilities as described in this disclosure.

According to aspects of the present disclosure, the payment system 200 also includes an authentication system 202. Details of the authentication system 202 will be discussed below. To briefly summarize some of the functionality of the authentication system 202, it manages authentication processes in connection with online purchase transactions (including device authentication processes in accordance with aspects of the present disclosure; and also possibly including other types of authentications, such as user authentications). In some embodiments, the authentication system 202 may be operated by the operator of the payment network 112.

The payment system 200 may further include a device verification profile server computer 204. The device verification profile server computer 204 may be in communication with the authentication system 202. The device verification profile server computer 204 may be a source of reference data for the authentication system 202 in connection with device authentication processes performed by the authentication system 202. The device verification profile server computer 204 may be under common operation with the authentication system 202. Details of the authentication system 202 and the device verification profile server computer 204 will be provided below.

Still further, the payment system 200 may include an offers server computer 206. The offers server computer will be described in more detail below. As a brief overview, it is to be understood that the offers server computer 206 may store data indicative of offers that may be presented to the user 103 at appropriate times via the customer device 104a. The selection of the offer(s) to be presented may be in accordance with aspects of the present disclosure.

To discuss the subject matter of FIG. 2 more generally, it should be understood that in most cases, blocks labeled therein with names/descriptions of entities should also be understood to represent computer systems operated by or for such entities.

It should also be understood that, for at least some types of participants in the payment system 200, there may be a considerable or even a very large number of participants of those types in practical embodiments of the payment system 200. Moreover, one or more components of the payment system 200 may handle in-store purchase transactions and/or other types of transactions in addition to online purchase transactions.

In some embodiments, any two or more of the authentication system 202, the offers server computer 206, and/or the device verification server computer 204 may be constituted by components of an interrelated and/or integrated computer system and/or may be housed together in a single data center.

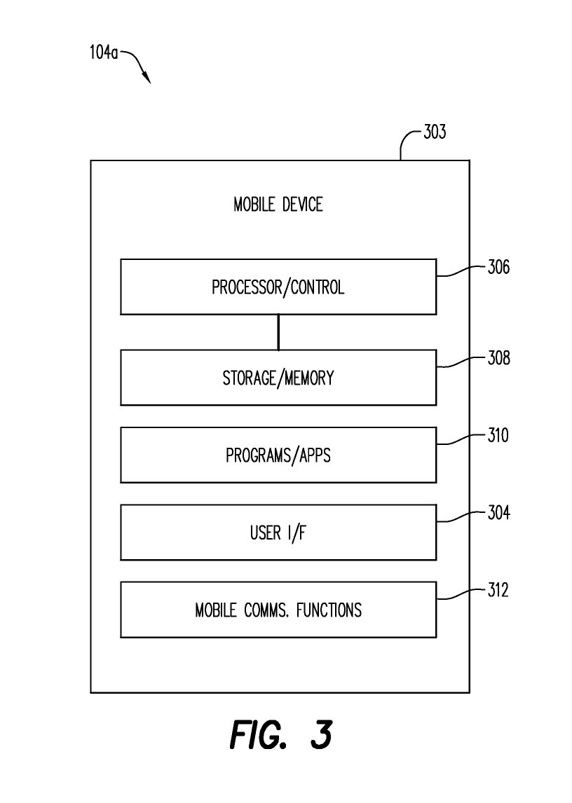

FIG. 3 is a block diagram of a typical mobile device that may be used in connection with the payment system 200 of FIG. 2. In particular, it is assumed (though this assumption should not be taken to be limiting), that the customer device 104a is embodied at a smartphone or other mobile device.

Continuing to refer to FIG. 3, the mobile device 104a may include a housing 303. In many embodiments, the front of the housing 303 is predominantly constituted by a touchscreen (not separately shown), which is a key element of the user interface 304 of the mobile device 104a.

The mobile device 104a further includes a mobile processor/control circuit 306, which is contained within the housing 303. Also included in the mobile device 104a is a storage/memory device or devices (reference numeral 308). The storage/memory devices 308 are in communication with the processor/control circuit 306 and may contain program instructions to control the processor/control circuit 306 to manage and perform various functions of the mobile device 104a. As is well-known, a device such as mobile device 104a may function as what is in effect a pocket-sized personal computer (assuming for example that the mobile device is a smartphone), via programming with a number of application programs, or “apps”, as well as a mobile operating system (OS). (The apps are represented at block 310 in FIG. 3, and may, along with other programs, in practice be stored in block 308, to program the processor/control circuit 306.) In accordance with aspects of the present disclosure, the programs/apps 310 may include one or more suitable apps for generating and/or detecting statistics, as described below, that characterize the particular mobile device 104a as to operation of its apps and/or in other respects.

As is typical for mobile devices, the mobile device 104a may include mobile communications functions as represented by block 312. The mobile communications functions 312 may include voice and data communications via a mobile communication network with which the mobile device 312 is registered. Although not separately shown in FIG. 3, it should be understood that the mobile communications functions 312 may include hardware aspects such as a microphone, a speaker, an antenna, a transceiver circuit, etc., all supported in and/or on the housing 303. The antenna, for example, may receive signals from and transmit signals to a mobile communications network (not shown).

From the foregoing discussion, it will be appreciated that the blocks depicted in FIG. 3 as components of the mobile device 104a may in effect overlap with each other, and/or there may be functional connections among the blocks which are not explicitly shown in the drawing. It may also be assumed that, like a typical smartphone, the mobile device 104a may include a rechargeable battery (not shown) that is contained within the housing 303 and that provides electrical power to the active components of the mobile device 104a.

It has been posited that the mobile device 104a may be embodied as a smartphone, but this assumption is not intended to be limiting, as mobile device 104a may alternatively, in at least some cases, be constituted by a tablet computer or by other types of mobile computing devices.

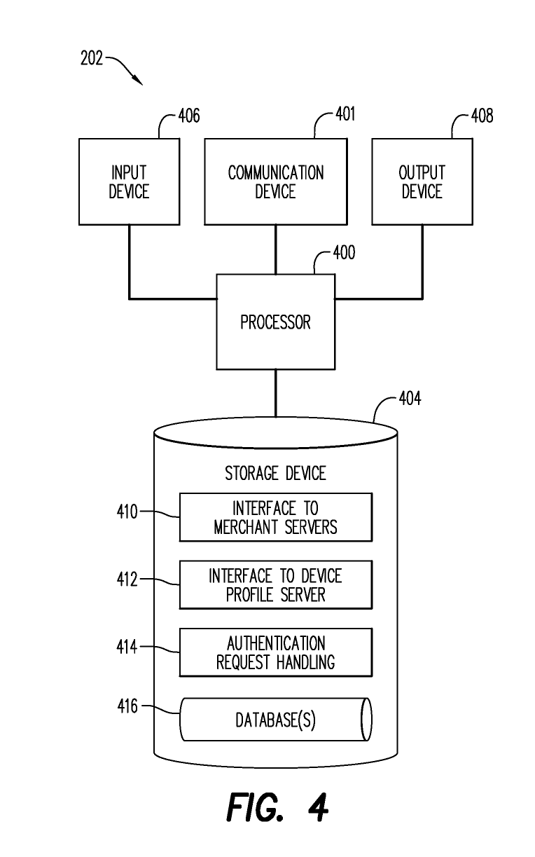

FIG. 4 is a block diagram representation of an embodiment of the authentication system 202.

In some embodiments, hardware aspects of the authentication system 202 may be constituted by typical server computer hardware, but may be controlled by software to cause it to function as described herein.

The authentication system 202 may include a processor 400 operatively coupled to a communication device 401, a storage device 404, an input device 406 and an output device 408. The communication device 401, the storage device 404, the input device 406 and the output device 408 may all be in communication with the processor 400.

The processor 400 may be constituted by one or more processors. The processor 400 may operate to execute processor-executable steps, contained in program instructions described below, so as to control the authentication system 202 to provide desired functionality.

Communication device 401 may be used to facilitate communication with, for example, other devices (such as e-commerce servers and the device verification profile server computer 204). For example, communication device 401 may comprise numerous communication ports (not separately shown), to allow the authentication system 202 to perform its roles in connection with numerous simultaneous online purchase transactions.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the authentication system 202, executed by the processor 400 to cause the authentication system 202 to function as described herein.

The programs may include one or more conventional operating systems (not shown) that control the processor 400 so as to manage and coordinate activities and sharing of resources in the authentication system 202, and to serve as a host for application programs (described below) that run on the authentication system 202.

The programs stored in the storage device 404 may also include a software interface 410 that controls the processor 400 to support communication between the authentication system 202 and merchant e-commerce servers such as the computer represented by block 102a in FIG. 2.

Further, and continuing to refer to FIG. 4, the storage device 404 may include a software interface 412 that controls the processor 400 to support communication between the authentication system 202 and the device verification profile server computer 204.

In addition, the storage device 404 may store an authentication request handling application program 414. The authentication request handling application program 414 may control the processor 400 such that the authentication system 202 provides functionality as described herein in connection with requests for device authentication related to online purchase transactions.

The storage device 404 may also store, and the authentication system 202 may also execute, other programs, which are not shown. For example, such programs may include a reporting application, which may respond to requests from system administrators for reports on the activities performed by the authentication system 202. The other programs may also include, e.g., device drivers, database management programs, communications software, etc.

The storage device 404 may also store one or more databases (reference numeral 416) required for operation of the authentication system 202.

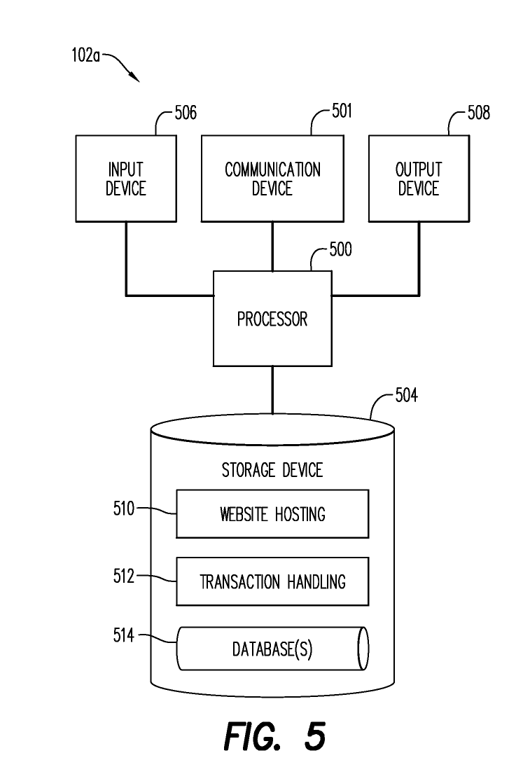

FIG. 5 is a block diagram of an embodiment of the e-commerce server 102a.

In its hardware architecture and components, the e-commerce server 102a may, for example, resemble the hardware architecture and components described above in connection with FIG. 4. However, the e-commerce server 102a may be programmed differently from the authentication system 202 so as to provide different functionality.

Returning again to the hardware aspects of the e-commerce server 102a, it may include a processor 500, a communication device 501, a storage device 504, an input device 506 and an output device 508. The communication device 501, the storage device 504, the input device 506 and the output device 508 may all be in communication with the processor 500.

The above descriptions of the hardware components shown in FIG. 4 may, in some embodiments, also be applicable to the like-named components shown in FIG. 5.

Storage device 504 stores one or more programs for controlling processor 500. The programs comprise program instructions (which may be referred to as computer readable program code means) that contain processor-executable process steps of the e-commerce server 102a, executed by the processor 500 to cause the e-commerce server 102a to function as described herein.

The programs may include one or more conventional operating systems (not shown) that control the processor 500 so as to manage and coordinate activities and sharing of resources in the e-commerce server 102a, and to serve as a host for application programs (described below) that run on the e-commerce server 102a.

The programs stored in the storage device 504 may also include website hosting software 510 that controls the processor 500 to enable the e-commerce server 102a to host a merchant's e-commerce website. In some embodiments, the website hosting software may provide functionality commonly available with respect to hosting of online shopping websites.

Further, the storage device 504 may store a transaction handling application program 512. The transaction handling application program 512 may control the processor 500 such that the e-commerce server 102a handles online shopping transactions as requested by customers who visit the merchant's e-commerce website. In some embodiments, the transaction handling application program 512 may provide functionality commonly available with respect to online shopping transactions. In some embodiments, the transaction handling application program 512 may also support functionality related to requesting device authentication—from the authentication system 202—in relation to online shopping transactions, and in accordance with aspects of the present disclosure.

Continuing to refer to FIG. 5, the storage device 504 may also store, and the e-commerce server 102a may also execute, other programs, which are not shown. For example, such programs may include a reporting application, which may respond to requests from system administrators for reports on the activities performed by the e-commerce server 102a. The other programs may also include, e.g., device drivers, database management programs, communications software, etc.

The storage device 504 may also store one or more databases (reference numeral 514) required for operation of the e-commerce server 102a.

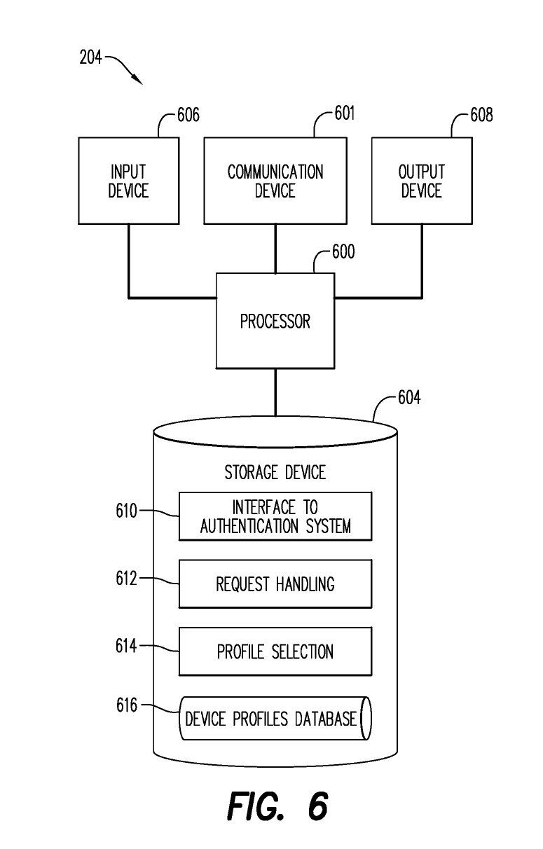

FIG. 6 is a block diagram of an embodiment of the device verification profile server computer 204.

In its hardware architecture and components, the device verification profile server computer 204 may, for example, resemble the hardware architecture and components described above in connection with FIG. 4. However, the device verification profile server computer 204 may be programmed differently from the authentication system 202 and the e-commerce server 102a so as to provide different functionality.

Returning again to the hardware aspects of the device verification profile server computer 204, it may include a processor 600, a communication device 601, a storage device 604, an input device 606 and an output device 608. The communication device 601, the storage device 604, the input device 606 and the output device 608 may all be in communication with the processor 600.

The above descriptions of the hardware components shown in FIG. 4 may, in some embodiments, also be applicable to the like-named components shown in FIG. 6.

Storage device 604 stores one or more programs for controlling processor 600. The programs comprise program instructions (which may be referred to as computer readable program code means) that contain processor-executable process steps of the device verification profile server computer 204, executed by the processor 600 to cause the device verification profile server computer 204 to function as described herein.

The programs may include one or more conventional operating systems (not shown) that control the processor 600 so as to manage and coordinate activities and sharing of resources in the device verification profile server computer 204, and to serve as a host for application programs (described below) that run on the device verification profile server computer 204.

The programs stored in the storage device 604 may include a software interface 610 that controls the processor 600 to support interactions between the device verification profile server computer 204 and the authentication system 202.

Further, the storage device 604 may store a request handling program 612 that handles requests from the authentication system 202 for access to device profiles that are stored in the device verification profile server computer 204. Associated with the request handling program 612—and also stored in the storage device 604 for controlling the processor 600—is a profile selection application program 614. As discussed further below, the device verification profile server computer 204 may store more than one device profile for a given device (e.g., one profile indicative of characteristic usage of the device while the user is at work, plus another profile indicative of characteristic usage of the device while the user is not at work), and the profile selection application program 614 may select between the two profiles depending on the time of day and/or day of the week when the request from the authentication system 202 is received at the device verification profile server computer 204.

The storage device 604 may also store, and the device verification profile server computer 204 may also execute, other programs, which are not shown. For example, such programs may include a reporting application, which may respond to requests from system administrators for reports on the activities performed by the device verification profile server computer 204. The other programs may also include, e.g., device drivers, database management programs, communication software, etc.

The storage device 604 may also store a database 616 of the above-mentioned device profiles. As discussed in more detail below, the device profiles stored in the database 616 may be uploaded to the device verification profile server computer 204 in a number of ways, including for example direct interactions between user mobile devices and the device verification profile server computer 204. In these interactions, for example, an app on the mobile device may upload statistics and other information indicative of characteristics of the mobile device and/or its apps and/or usage of the apps on the mobile device.

The storage device 604 may also store one or more other databases (not shown) as may be required to permit operation of the device verification profile server computer 204.

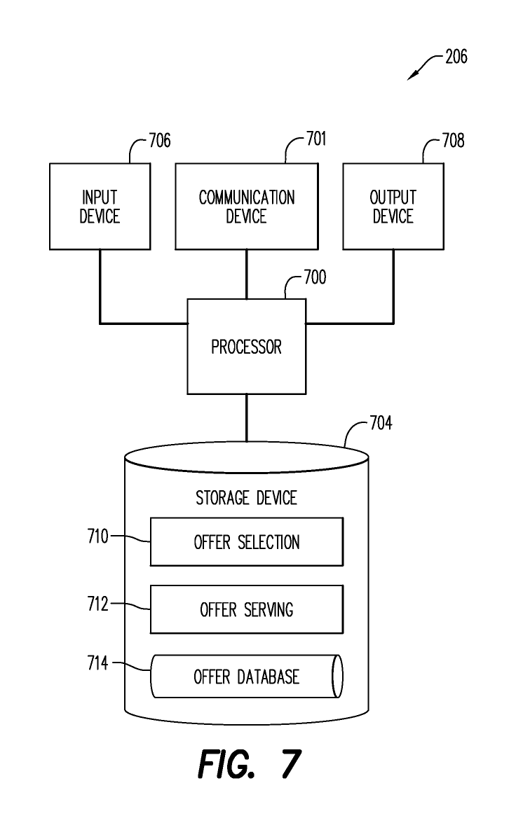

FIG. 7 is a block diagram of an embodiment of the offers server computer 206.

In its hardware architecture and components, the offers server computer 206 may, for example, resemble the hardware architecture and components described above in connection with FIG. 4. However, the offers server computer 206 may be programmed differently from the authentication system 202, the e-commerce server 102a and the device verification profile server computer 204 so as to provide different functionality.

Returning again to the hardware aspects of the offers server computer 206, it may include a processor 700, a communication device 701, a storage device 704, an input device 706 and an output device 708. The communication device 701, the storage device 704, the input device 706 and the output device 708 may all be in communication with the processor 700.

The above descriptions of the hardware components shown in FIG. 4 may, in some embodiments, also be applicable to the like-named components shown in FIG. 7.

Storage device 704 stores one or more programs for controlling processor 700. The programs comprise program instructions (which may be referred to as computer readable program code means) that contain processor-executable process steps of the offers server computer 206, executed by the processor 700 to cause the offers server computer 206 to function as described herein.

The programs may include one or more conventional operating systems (not shown) that control the processor 700 so as to manage and coordinate activities and sharing of resources in the offers server computer 206, and to serve as a host for application programs (described below) that run on the offers server computer 206.

The programs stored in the storage device 704 may include an offer selection application program 710 that controls the processor 700 to select offers for presentation to users. Details of functionality provided by the offer selection application program 710 will be described below.

Further, the storage device 704 may store an application program 712 that handles dispatching/transmitting to users the offers selected by the offer selection application program 710. The offer transmitting (or “serving”) application program 712 may be closely associated with or integrated with the offer selection application program 710. Details of functionality provided by the offer transmitting application program 712 will be described below.

The storage device 704 may also store, and the offers server computer 206 may also execute, other programs, which are not shown. For example, such programs may include a reporting application, which may respond to requests from system administrators for reports on the activities performed by the offers server computer 206. The other programs may also include, e.g., device drivers, database management programs, communication software, etc.

The storage device 704 may also store a database 714 of offers available for selection by the offer selection application program 710. The database may also include criteria for selection of the offers. The criteria for selection may be stored with the respective offers in the offers database 714. The storage device 704 may also store one or more other databases (not shown) as may be required to permit operation of the offers server computer 206.

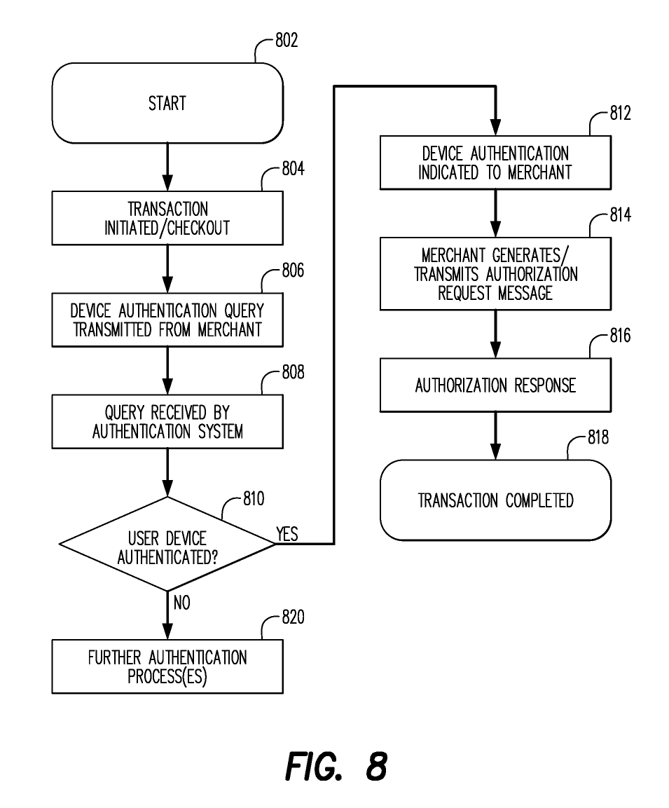

FIG. 8 is a flow chart that illustrates a process that may be performed in the system 200 according to aspects of the present disclosure. The process of FIG. 8 is concerned with device authentication based on characteristics of the user's device such as app usage characteristics of the user device. The user device may be, for example, the mobile device 104a referred to above in connection with FIGS. 2 and 3.

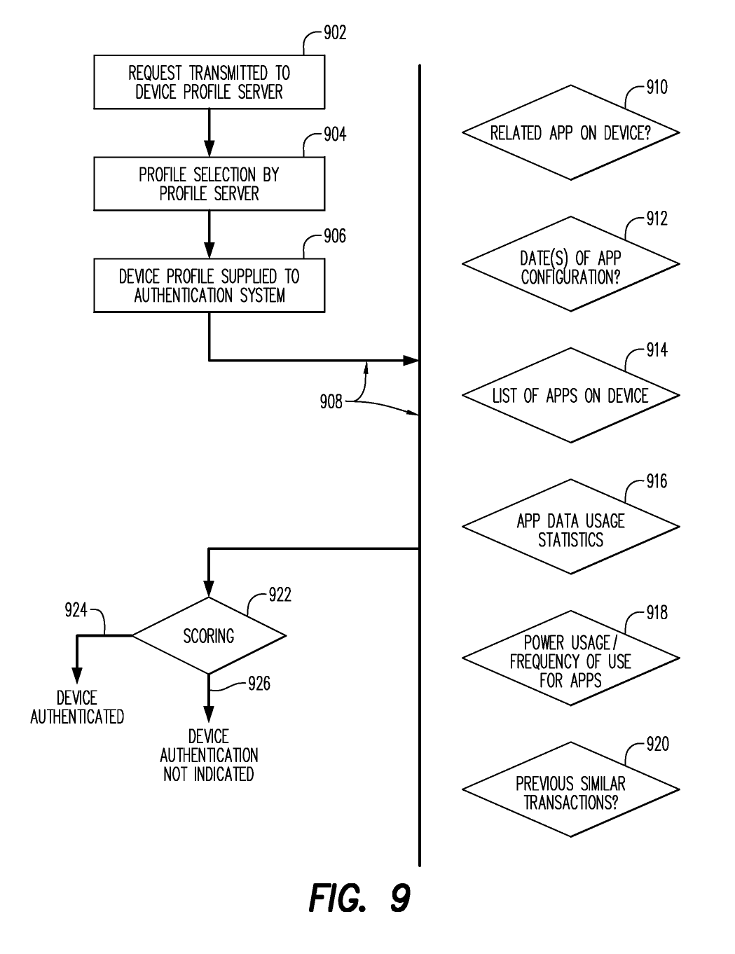

As will be seen, FIG. 9 is a flow chart that illustrates some details of the process represented by FIG. 8.

Referring now to FIG. 8, block 802 represents the start of the process. At block 804, an online shopping transaction occurs, via the mobile device 104a and the e-commerce server 102a (FIG. 2). Also encompassed in block 804 is entry into the checkout phase of the online shopping transaction. (It will be appreciated that the user of the mobile device 104a may have initiated both the online purchase transaction and then the checkout phase after selection of purchased items was completed.) As part of the checkout process, the mobile device 104a may provide—to the e-commerce server 102a—a current profile or signature of use of apps on the mobile device 104a and/or other information about apps on the mobile device 104a and/or other information about the mobile device 104a. The purpose of providing this information, as will be seen, is to facilitate a device authentication process, which will be described below. Examples of the type of information that may be provided from the mobile device 104a to the e-commerce server 102a may include: (a) the presence in the mobile device 104a of one or more apps that are related to the particular transaction; (b) a partial or complete list of apps stored in/running on the mobile device 104a; (c) one or more dates on which corresponding apps were configured for use on the mobile device 104a; (d) statistics as to the apps' amount of data usage over a predetermined period of time prior to the time of the transaction (this may be by individual app and/or by category of app); (e) statistics regarding apps' usage by total time of usage over a predetermined period of time prior to the time of the transaction and/or frequency of usage over such a period of time and/or amount of power used by app or category of app during such a period of time. In addition or alternatively, the information provided from the mobile device 104a to the e-commerce server 102a may include other app-related statistics, such as consumption by app of resources such as memory, CPU, battery power and network usage. Many or all of such statistics may be regularly calculated, collated and/or maintained by the mobile operating system on the mobile device 104a and/or by one or more utility programs running on the mobile device 104a. In some embodiments, a wallet app or payment app on the mobile device 104a may have been modified—in accordance with aspects of the present disclosure—to obtain one or more of these types of data from the mobile OS or other relevant software entity on the mobile device 104a. In addition or alternatively, a dedicated app for compiling such current device profile information may have been installed on the mobile device 104a and may perform that data gathering/compiling as referred to above.

In some embodiments, the mobile device 104a may also provide—with the current device profile information—a device identifier (ESN, MEID, IMEI—i.e., “Electronic Serial Number”, “Mobile Equipment Identifier”, “International Mobile Equipment Identity” or the like) and/or one or more application identifiers (i.e., a serial number or unique individual identifying code, etc.) for the wallet and/or payment apps utilized for the current transaction.

It will also be appreciated that in conjunction with the current device profile, the e-commerce server 102a may also have received payment credential information such as a payment account number/payment token and related information. This information may have been transferred to the e-commerce server 102a via a wallet or payment app on the mobile device 104a, and/or from WSP 106 (FIG. 2), or may have been at least partially manually entered by the user 103 via the user interface of the mobile device 104a.

At block 806 in FIG. 8, the e-commerce server 102a transmits a query to the authentication system 202, to request that the authentication system attempt to authenticate the mobile device 104a employed by the user 103 in performing the transaction (referred to at block 804) with the e-commerce server 102a. The query may include information about the transaction, as well as some or all of the current device profile information provided from the mobile device 104a to the e-commerce server 102a.

Block 808 in FIG. 8 represents the authentication system 202 receiving the query transmitted by the e-commerce server 102a at block 806.

Decision block 810 may follow block 808 in the process of FIG. 8. At decision block 810, it is determined whether the user device is to be considered to have been authenticated. This determination may be made at the authentication system 202, the e-commerce server 102a or by both of those components in cooperation with each other.

FIG. 9 may be considered a decomposition or more detailed illustration of processing performed in connection with decision block 810 of FIG. 8. Reference will now be made to FIG. 9.

At block 902 in FIG. 9, the authentication system 202 may transmit a request to the device verification profile server computer 204. The purpose of the request may be to obtain a relevant reference device profile from the device verification profile server computer 204. It is to be understood that reference device profile information was previously stored in the device verification profile server computer 204. This may have been done during a set up process for the user's wallet/payment app and/or in connection with the user's signing on for participation in an upgraded user/device authentication system such as is described herein. In addition or alternatively, the mobile device may provide updated reference device profile information on a regular or occasional basis to help assure that the reference device profile information stored in the device verification profile server computer 204 does not grow stale. In some embodiments, either or both of initial or updated storage of reference device profile information may involve direct interaction “over the air” (via a communication channel that is not shown but may include a mobile communication network) between the mobile device 104a and the device verification profile server computer 204. During such an interaction, an app in the mobile device 104a may upload the reference data to the device verification profile server computer 204 for storage in the device verification profile server computer 204.

How a mobile device is used, and particularly—what apps are used and how much they are used—may vary according to whether the user is at work, off from work, or traveling. Accordingly, as noted above, it may be desirable for the device verification profile server computer 204 to store more than one reference device profile for a given device to reflect those differences in usage. In some embodiments, the app which collects profile data may “learn” time- and/or location-related characteristics of the user's mobile device usage habits and may assemble multiple reference device profiles accordingly, including time/day-of-week/location cues to indicate what reference profile is relevant depending on where the user is and/or when the reference device profile is being consulted. The resulting profiles may be uploaded for storage from the mobile device to the device verification profile server computer 204.

One or more reference device profiles may be indexed by device identifier (or alternatively by app identifier) in the device profiles database 616 (FIG. 6) of the device verification profile server computer 204.

In view of the above, block 904 in FIG. 9, shown in phantom, indicates that the device verification profile server computer 204 (in response to the request at block 902) may select from among two or more reference device profiles stored by the device verification profile server computer 204 for the mobile device in question. The selection of reference device profile may, for example, be based on the current location of the mobile device, the current time of day and/or the current day of the week. It will be noted that the process of block 904 may not be necessary if there is only one reference device profile stored for the mobile device.

At block 906 in FIG. 9, the device verification profile server computer 204 transmits—to the authentication system 202—the relevant reference device profile. The latter may be either the profile selected at 904 (if there was more than one reference device profile stored for the mobile device) or the sole reference device profile stored for the mobile device in the device verification profile server computer 204.

As indicated at 908, the authentication system 202 may proceed to compare the current device profile information received with the query at block 808 (FIG. 8) with the relevant reference device profile supplied by the device verification profile server computer 204 at 906; the authentication system 202 may perform other pertinent processing as well. Decision blocks 910, 912, 914, 916, 918, 920 in FIG. 9 represent respective dimensions along which the current-to-reference profile comparison may be made; or according to which other relevant authentication processing may be performed. In some embodiments, and/or in some cases, some of the dimensions reflected at 910-920 may be omitted and/or other and/or additional dimensions of comparison may be employed.

According to decision block 910, it may be determined whether a related application is installed in or configured on the mobile device. For example, the related device may be a shopping app for a particular merchant (e.g., the merchant that operates the e-commerce server 102a).

According to decision block 912, dates of configuration/installation of various apps, as reflected in the current device profile information, may be compared with configuration/installation dates for those apps on record in the reference device profile. (To give a possibly simplified example, if the reference profile indicates that the “Spotify” app was installed in the mobile device on a certain date about three years before, and that the “Pandora” app was installed on a certain date about 18 months before—and if the current device profile indicates the same dates of installation for the same apps on the mobile device—then this may be highly probative that the device is authentic.)

According to decision block 914, a current roster of apps present in the mobile device may be compared with a reference roster of apps. In some embodiments, the comparison of “apps-present” may be by category of app. Because apps may come and go (some new apps installed; some de-installed) a 100% match between current and reference rosters may be unlikely, but a fairly high degree of correspondence between the two rosters may have considerable probative value as to whether the device is authentic.

According to decision block 916, the amount(s) of data used statistic(s) (by app and/or category of app) as reported in the current device profile may be compared with corresponding statistic(s) in the reference device profile. For example, current data usage by a messaging app may be compared with a reference value for that statistic.

According to decision block 918, statistics in the current profile relating to frequency of usage and/or power consumption by app (and/or category of app) may be compared with corresponding statistics in the reference device profile.

According to decision block 920, in a dimension not necessarily related to device characteristics, the authentication system 202 may determine whether the current transaction is similar (e.g., in merchant or merchant category, in transaction amount and/or in type of item(s) purchased) to previous (or recent previous) transactions in which the same user device was employed. If so, this may tend to be probative of the authenticity of the user device employed for the current transaction.

Pattern matching analysis for the current device profile/current transaction versus the reference profile and/or prior transactions may be applied dimension by dimension and/or as to groups of dimensions and/or as to all dimensions together. The results or result may be a set of scores or a single score. The score or scores may be evaluated (decision block 922, FIG. 9), and a conclusion may be drawn as to whether the user device employed for the current transaction should be deemed to be authenticated (branch 924 from decision block 922), or not indicated to be authenticated (branch 926 from decision block 922). (For example, the score or scores may be compared with a classification threshold or thresholds.) In some embodiments, this determination may be made at the authentication system 202. In other embodiments, or in other cases, the authentication system 202 may provide one or more scores generated from the pattern matching analysis to the e-commerce server 102a, and the e-commerce server 102a may make the final determination as to whether the user device should be considered to be authenticated.

In some embodiments, where the authentication system 202 makes the determination as to device authentication, the authentication system 202 may provide (as per block 812, FIG. 8) a suitable code to the e-commerce server 102a to indicate that device authentication has been determined. Then at block 814, the merchant/e-commerce server 102a may generate a more or less conventional transaction authorization request message to be routed to the account issuer (in a manner described above in connection with FIG. 1). At block 816, the merchant/e-commerce server 102a may receive an authorization response (i.e., reflecting the account issuer's determination as to whether all is in order with the user's payment account). Block 818 represents completion of the online shopping transaction.

It will be noted that blocks 812-818 in FIG. 8 follow from the “yes” (i.e., “device authenticated”) branch of decision block 810 in FIG. 8. However, if a negative determination is made at decision block 810 (i.e., if device authentication is not indicated), then the “no” branch from decision block 810 may be followed to block 820. At block 820, for example, a user authentication process may be performed. For example, a password-entry or biometric challenge may be issued to the user from the authentication system 202 via the mobile device 104a.

With a device authentication process as described above, characteristics of a mobile device, including for example resident apps or usage statistics or patterns regarding the apps may be employed to arrive at a device authentication conclusion with sufficient confidence that transaction approval or completion may occur without engaging in less convenient security measures such as user authentication. Device authentication as described herein may be seamless and/or invisible to the user, and may promote higher rates of completion of online purchase transactions. In this way, there may be an improved trade-off between transaction security and user convenience.

In some embodiments, some component of the system 200 (e.g., the wallet app or other app that collects app-related statistics for reporting to the e-commerce server 102a of for other purposes) may be configured to recognize new patterns in app usage on the mobile device 104a. In this context, “new patterns” refers to app usage that differs from known or established app usage patterns. When a new app usage pattern is detected, the wallet app (or other app that collects app-related statistics) may initiate a process in which the user is challenged to satisfy a user-authentication process (e.g., PIN-entry or biometric characteristic scan). If the user authentication process is completed successfully (i.e., user authentication is confirmed), then the new usage pattern may be stored and recognized as a valid device profile. In this way, usage pattern learning by the system may be supported.

Although the prior discussion has assumed that a handheld mobile device was utilized as the user's device in the transaction illustrated in FIGS. 2, 8 and 9, the teachings of this disclosure are not so limited. As an alternative, for example, the user's device may be, for example, a personal computer (PC) or a laptop computer. As to computers of this kind, reference and current device profiles—including (e.g.) statistics relative to application programs—may be stored/generated/compared, etc. in a manner similar to that illustrated in, and described with reference to, FIGS. 8 and 9.

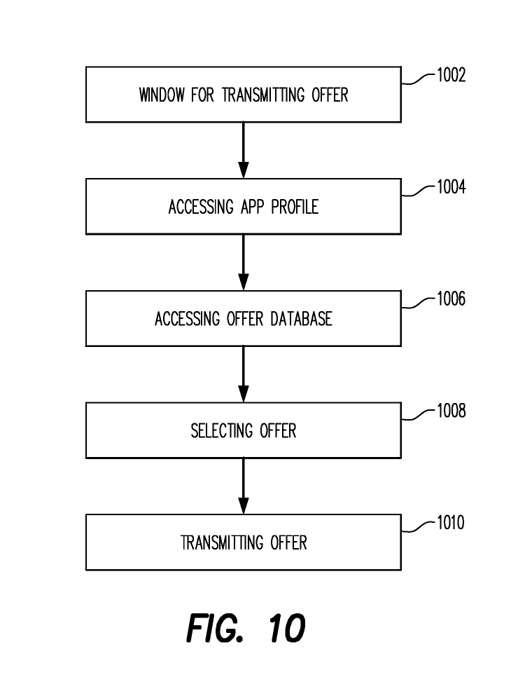

FIG. 10 is a flow chart that illustrates another process that may be performed in the system 200 according to aspects of the present disclosure.

At 1002 in FIG. 10, it may be determined (e.g., by the e-commerce server 102a) that it is an appropriate time to transmit a promotional/customer loyalty offer or the like to the user 103 via the user's device 104a. (For example, the current moment may be part of a brief waiting period while the e-commerce server 102a is awaiting the authorization response referred to above in block 816 in FIG. 8.)

At block 1004, the e-commerce server 102a may access some or all of a current and/or reference device profile for the user device. For example, the e-commerce server 102a may access a roster of apps on the device, frequency of use statistics for apps, and/or overall time of usage on an app-by-app basis. In some embodiments, the app usage statistics or other characteristics may be indicative of app usage patterns on the mobile device 104a, and the app usage patterns may be used to select advertising messages, offers and/or coupons to be sent to the user 103. The e-commerce server 102a may supply some or all of this information to the offers server computer 206.

At block 1006, the offers server computer 206 may access the offer database 714 (FIG. 7). For example, the offers server computer 206 may search the offer database 714 based on one or more device/app characteristics obtained from the e-commerce server 102a. The searching of the offer database 714 may identify criteria in the offer database 714 reflected in the device/app characteristics that indicate that one or more offers should be selected from the offer database 714 for presentation to the user.

At block 1008, the offers server computer 206 may select one or more offers for presentation to the user. For example, if one of the apps on the user device (as indicated from data supplied by the e-commerce server 102a) is a subscription app to a national newspaper, an offer for a discounted digital-only subscription to a news magazine may be selected from the offer database 714 by the offers server computer 206. In such a case, a second offer (e.g. for an e-book about current events) may also be selected. As another example, if one of the apps on the user device is a free game, the offers server computer 206 may select a discounted offer to sell a similar but more challenging game for downloading to the user device.

At 1010, the offer(s) selected at 1008 is (are) transmitted to the user device (e.g. as a pop-up) via the e-commerce server 102a.

The process as described in connection with FIG. 10 may make advantageous use of device profile information to allow a merchant or another party to make attractive offers to the user of the user device that is being employed for the transaction pictured in FIG. 2.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” (or, equivalently, “payment account system” or “payment system”) refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving current device profile data with respect to a mobile device;
comparing the received current device profile data with stored reference device profile data; and
making a device authentication determination with respect to the mobile device based at least in part on a result of the comparing step;
said received current device profile data and said stored reference device profile data indicative of at least one application program characteristic of the mobile device.

2. The method of claim 1, further comprising:
before the receiving step, storing a plurality of device profiles for said mobile device; and
before the comparing step, selecting one of said plurality of device profiles for use in said comparing step.

3. The method of claim 2, wherein said selecting is based on at least one of (a) a current location of the mobile device; (b) a current time of day; and (c) a current day of the week.

4. The method of claim 1, wherein the device authentication determination indicates approval of a transaction being performed by the mobile device.

5. The method of claim 4, wherein the transaction is a payment account system transaction.

6. The method of claim 1, wherein the device authentication determination indicates initiating a user authentication process with respect to a transaction being performed by the mobile device.

7. The method of claim 1, wherein said at least one application program characteristic of the mobile device includes at least one of: (a) a list of at least one application program stored in the mobile device; (b) at least one date on which a respective application program was installed or configured in the mobile device; and (c) an application program usage pattern of the mobile device.

8. The method of claim 7, wherein the application program usage pattern includes statistics indicative of (i) respective amounts of data usage attributable to respective application programs; (ii) respective frequencies of usage attributable to respective application programs; and (iii) respective amounts of power usage attributable to respective application programs.

9. A method comprising:
storing a device profile with respect to a mobile device, the device profile including at least one application program characteristic of the mobile device;
selecting an offer message, said selecting based at least in part on the device profile; and
sending the selected offer message to the mobile device.

10. The method of claim 9, wherein said at least one application program characteristic of the mobile device includes at least one of: (a) a list of at least one application program stored in the mobile device; (b) at least one date on which a respective application program was installed or configured in the mobile device; and (c) an application program usage pattern of the mobile device.

11. The method of claim 10, wherein the at least one application program characteristic identifies at least one application program that runs on the mobile device.

12. The method of claim 11, wherein:
the at least one application program includes an application program for reading a first digital journalism publication; and
the selected offer message includes an offer of (a) a digital subscription to a second digital journalism publication different from the first digital journalism publication, or (b) an e-book.

13. The method of claim 11, wherein:
the at least one application program includes a first mobile device game program; and
the selected offer message includes an offer to purchase a second mobile device game program different from the first mobile device game program.

14. The method of claim 10, wherein the application program usage pattern includes statistics indicative of (i) respective amounts of data usage attributable to respective application programs; (ii) respective frequencies of usage attributable to respective application programs; and (iii) respective amounts of power usage attributable to respective application programs.

15. An apparatus comprising:
a processor; and
a memory in communication with the processor, the memory storing program instructions, the processor operative with the program instructions to perform functions as follows:
receiving current device profile data with respect to a mobile device;
comparing the received current device profile data with stored reference device profile data; and
making a device authentication determination with respect to the mobile device based at least in part on a result of the comparing step;
said received current device profile data and said stored reference device profile data indicative of at least one application program characteristic of the mobile device.

16. The apparatus of claim 15, wherein the processor is further operative with the program instructions to perform functions as follows:
before the receiving step, storing a plurality of device profiles for said mobile device; and
before the comparing step, selecting one of said plurality of device profiles for use in said comparing step.

17. The apparatus of claim 16, wherein said selecting is based on at least one of (a) a current location of the mobile device; (b) a current time of day; and (c) a current day of the week.

18. The apparatus of claim 15, wherein the device authentication determination indicates approval of a transaction being performed by the mobile device.

19. The apparatus of claim 18, wherein the transaction is a payment account system transaction.

20. The apparatus of claim 15, wherein the device authentication determination indicates initiating a user authentication process with respect to a transaction being performed by the mobile device.
